(19) United States
(12) Patent Application Publication
(10) Pub. No.: US 2015/0299020 A1
(43) Pub. Date: Oct. 22, 2015

(54) PADS, METHODS OF FORMING SCRIBING MARK, AND METHODS OF CUTTING A SHEET OF GLASS

(71) Applicant: CORNING INCORPORATED, Corning, NY (US)

(72) Inventors: Yixing Bao, Painted Post, NY (US); Peter Lawrence Bocko, Painted Post, NY (US); Sean Matthew Garner, Elmira, NY (US); Yichun Wang, Painted Post, NY (US)

(21) Appl. No.: 14/646,865

(22) PCT Filed: Nov. 21, 2013
(86) PCT No.: PCT/US2013/071190

§ 371 Date: May 22, 2015

Related U.S. Application Data
(60) Provisional application No. 61/730,612, filed on Nov. 28, 2012.

(51) Int. Cl. C03B 33/10; B32B 3/26; B32B 5/18; B32B 27/36; B32B 27/32

(52) U.S. Cl. CPC C03B 33/105; B32B 27/36; B32B 27/32; B32B 5/18; B32B 3/266; B32B 2250/246; B32B 2307/536; B32B 2307/51

(57) ABSTRACT

Pads, for cutting thin glass on machines designed for thicker glass, are provided with variable viscoelasticity. In further examples, methods of cutting a thin sheet of glass on a machine designed for thicker glass include the step of placing a pad between a working surface and the sheet of glass. In still further examples, methods of forming a scribing mark on a sheet of glass include the step of placing a compressible pad between a sheet of glass and a working surface.

This application claims the benefit of priority under 35 U.S.C. §119 of U.S. Provisional Application Ser. No. 61/730612 filed on Nov. 28, 2012 the content of which is relied upon and incorporated herein by reference in its entirety.

### TECHNICAL FIELD

The present disclosure relates to apparatus and methods of forming a scribing mark, and methods of cutting a sheet of glass and, more particularly, to apparatus and methods of cutting a thin glass sheet, and methods of forming a scribing mark on a sheet of thin glass.

### BACKGROUND

One conventional way to cut a portion out of a sheet of glass involves forming a scribing mark on the sheet of glass and bending the sheet of glass around the scribing mark so as to detach or separate the portion from the rest of the sheet. In such a process, the quality of the scribing mark can affect the overall edge quality of the sheet of glass which, in turn, affects the glass strength. There is a need to repeatedly form scribing marks of satisfactory quality. However, it is difficult to form scribe marks on thin sheets of glass, for example, those with thickness of 0.2 mm or less, because typical glass cutters are designed for sheets of glass of higher thickness and cannot form scribe marks of acceptable quality on the thinner sheets of glass.

Therefore, there is a need for apparatus and methods of forming scribing marks on thin sheets of glass.

### SUMMARY

In a first aspect, a pad is configured to be subjected to a compressive force applied substantially along a thickness direction. The pad has variable viscoelasticity such that, as an applied compressive stress is continuously increased in an order of a first range and a second range, the viscoelasticity is lower when there is applied a compressive stress in the second range than when there is applied a compressive stress in the first range.

In one example of the first aspect, the pad includes a top layer and an intermediate layer. In one example, when there is applied a compressive stress in the first range, the viscoelasticity of the pad is exhibited by the top layer, and when there is applied a compressive stress in the second range, the viscoelasticity of the pad is exhibited by the intermediate layer. In another example, the intermediate layer having a porous configuration. In still another example, the pad further including a bottom layer and having variable viscoelasticity such that, as a compressive stress is applied in a third range, the compressive stress in the third range being greater than that applied in the second range, the viscoelasticity exhibited by the pad is lower when there is applied a compressive stress in the second range than when there is applied a compressive stress in the third range. For example, the pad can have variable viscoelasticity such that, when there is applied a compressive stress in the third range, the viscoelasticity of the pad is exhibited primarily by the top and bottom layers. In another example, the pad includes a plurality of passages extending in the thickness directions, the top layer, the intermediate layer and the bottom layer including a first set of holes, a second set of holes and a third set of holes respectively, the plurality of passages defined by alignment of the first set of holes, the second set of holes and the third set of holes.

In another example of the first aspect, the pad is made of polyvinyl chloride and polyester material.

In still another example of the first aspect, the pad has a thickness of about 1.5-2.2 mm.

In yet another example of the first aspect, the Shore A hardness is of 5-35 for the pad.

In still another example of the first aspect, the pad is configured to undergo greater deformation when there is applied a compressive stress in the second range than when there is applied a compressive stress in the first range such that a first range of reactive force exerted by the pad when there is applied a compressive stress in the first range is greater than a second range of reactive force exerted by the pad when there is applied a compressive stress in the second range.

The first aspect can be provided alone or in combination with any one or more examples of the first aspect discussed above.

In a second aspect, a method of cutting a sheet of glass includes the steps of placing a pad between a working surface and the sheet of glass and securing the sheet of glass relative to the working surface. The method further includes the steps of scribing the sheet of glass secured relative to the working surface and separating a portion of the sheet of glass from the sheet of glass.

In one example of the second aspect, the step of scribing includes applying an operating pressure on a scribing tool. The pad is configured to deform and absorb pressure applied to the glass sheet during the step of scribing such that an operating pressure applied on the scribing tool is greater by at least a predetermined amount when the sheet of glass is supported with the pad than an operating pressure applied on the scribing tool when the sheet of glass is not supported with the pad. In one example, the pressure applied on the sheet of glass with the pad is in a range of 29 to 43 kPa. In another example, the step of scribing the sheet of glass is conducted with a cutting wheel. For example, the cutting wheel may be configured so that at its closest possible position relative to the working surface, the cutting wheel is located at a given distance from the working surface, wherein the sheet of glass has a thickness less than the amount of the given distance, and wherein the thickness of the pad together with the thickness of the sheet of glass is an amount greater than the given distance.

In another example of the second aspect, the step of securing the sheet of glass involves applying suction force on the sheet of glass, the suction force extending through the pad. In one example, the suction force is applied from the working surface.

The second aspect can be provided alone or in combination with any one or more examples of the second aspect discussed above.

In a third aspect, a method of forming a scribing mark on a sheet of glass includes the step of placing a compressible pad between a sheet of glass and a working surface. The method further includes the step of moving a scribing tool from a starting position toward the working surface so as to contact the sheet of glass. The method further includes the step of applying a scribing force of a predetermined value on the sheet of glass using the scribing tool. The method also includes the step of moving the scribing tool further toward the working surface and into a scribing position so as to deform the compressible pad and move the sheet of glass toward the working surface without increasing the scribing force, applied on the sheet of glass by the scribing tool, significantly beyond the predetermined value. The scribing position reached by the scribing tool is at least a predetermined distance offset from the starting position, the predetermined distance measured in a direction substantially perpendicular to the working surface.

In a fourth aspect, a method of forming a scribing mark on a sheet of glass includes the step of placing a compressible pad between a sheet of glass and a working surface. The method further includes the step of moving a scribing tool toward the working surface so as to contact an elevation at which a top surface the sheet of glass is located. The method further includes the steps of applying an operating pressure on the scribing tool and maintaining the operating pressure within a predetermined range at which a viscoelasticity of the compressible pad is substantially different compared to operating pressures outside the predetermined range. The method further includes the step of moving the scribing tool further toward the working surface and into a scribing position so as to deform the compressible pad and move the sheet of glass toward the working surface, the scribing position reached by the scribing tool is at least a predetermined distance offset from the elevation, the predetermined distance measured in a direction substantially perpendicular to the working surface.

In one example, the thickness of the sheet of glass is about 0.1 mm or less in any of the second aspect, one or any number of examples of the second aspect, the third aspect and/or the fourth aspect discussed above.

### BRIEF DESCRIPTION OF THE DRAWINGS

These and other aspects are better understood when the following detailed description is read with reference to the accompanying drawings, in which:

FIG. 1 is a graph of load force acting on a sheet of glass against operating pressure applied on a scribing tool for different values of scribing depths;

FIG. 2 is a perspective view of an example embodiment of a compressible pad for scribing a sheet of glass and a partial exploded view of the compressible pad;

FIG. 3 is a cross-sectional view of an example embodiment of a scribing tool above an example working surface on which the compressible pad and a sheet of glass are placed;

FIG. 4 is a cross-sectional view of the example scribing tool moved to form a scribing mark on a sheet of glass;

FIG. 5 is a graph of compressive stress against compressive strain of the compressible pad;

FIG. 6 is a graph of load force acting on a sheet of glass against operating pressure applied on the scribing tool; and

FIG. 7 is a graph of load force acting on a sheet of glass with and without the compressible pad against operating pressure applied on the scribing tool where a coefficient of variation of the load force is indicated.

### DETAILED DESCRIPTION

Examples will now be described more fully hereinafter with reference to the accompanying drawings in which example embodiments are shown. Whenever possible, the same reference numerals are used throughout the drawings to refer to the same or like parts. However, aspects may be embodied in many different forms and should not be construed as limited to the embodiments set forth herein.

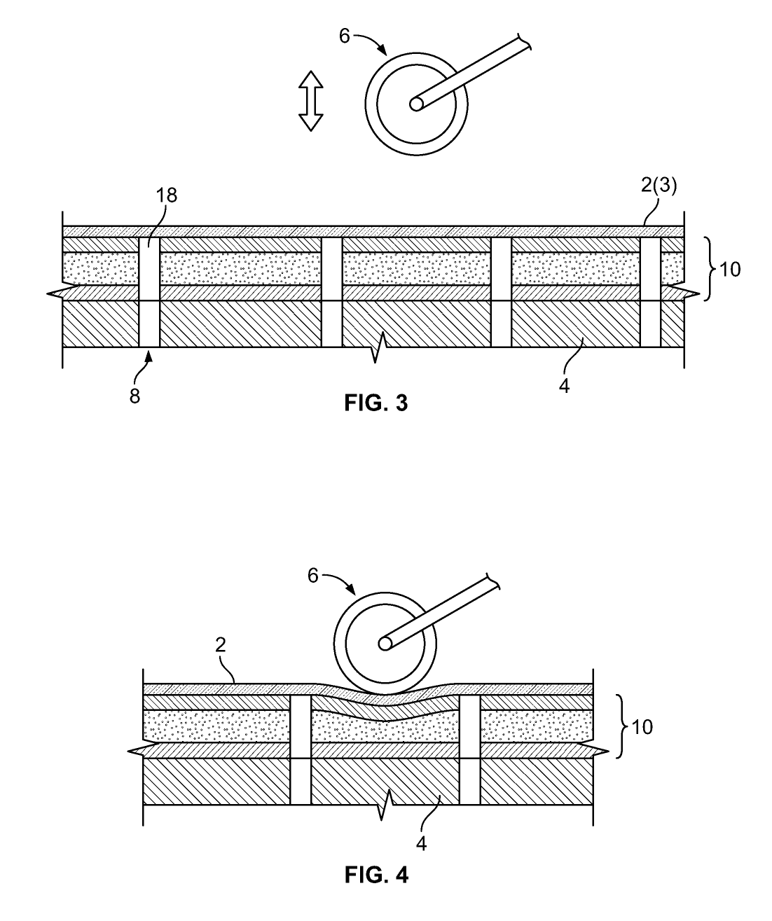

In an example scribing process, as shown in FIG. 3, a sheet of thin glass 2 may be placed on a working surface 4 and a scribing tool 6 of a cutting apparatus may be moved to contact the sheet of glass 2 and perform the scribing process thereon. The term “thin glass” as used herein means glass having a thickness of 0.2 mm or less, for example, 0.2, 0.19, 0.18, 0.17, 0.16, 0.15, 0.14, 0.13, 0.12, 0.11, 0.1, 0.09, 0.08, 0.07, 0.06, 0.05, 0.04, 0.03, 0.02, or 0.01 mm. The working surface 4 may be substantially planar although there may be irregularities present thereon. The working surface 4 may include a plurality of vacuum holes 8 configured to apply a suction force on the sheet of glass 2 and secure the sheet of glass 2 relative to the working surface 4. The scribing tool 6 may be embodied as a cutting wheel with a peripherally formed blade. The term “scribing” is meant to refer to a process of forming a flaw, a mark, a notch, for example, on the surface of the sheet of glass 2 such that a portion of the sheet of glass 2 can be detached or separated along the mark, the notch or the flaw by further manipulation of the sheet of glass 2 (e.g., bending). The term “scribing” can also include cutting the sheet of glass 2 but the cutting would only extend partially into the thickness of the sheet of the glass 2 rather than completely through the sheet of the glass 2. An operating pressure applied by the cutting apparatus on the scribing tool 6 may be adjusted by the cutting apparatus such that a range of scribing pressure values (associated with the load force values) can be applied to the sheet of glass 2. Moreover, the scribing tool 6 may be located above the working surface 4 in a starting position and may be moved or lowered from the starting position toward the working surface 4 so as to contact the sheet of glass 2. Furthermore, once the scribing tool 6 is sufficiently lowered to a scribing position, the scribing tool 6 may be moved across the sheet of the glass 2, by the cutting apparatus, so as to form a scribing mark. The scribing position may be altered by adjusting a predetermined distance by which the scribing tool is offset from the starting position where the predetermined distance is measured in a direction substantially perpendicular to the working surface 4.

The scribing tool 6 is part of a cutting apparatus and may be lowered or set to a range of scribing positions, a given distance above the working surface 4. The inventors have found that for cutting apparatuses designed to cut thicker glasses, there is a lowest point at which the scribing tool can be set. At its lowest point, for some machines, the inventors have found that the distance from the scribing tool to the work surface is greater than the thickness of thin glass. Accordingly, such machines cannot adequately form a scribe line in thin glass. Additionally, for such machines designed to cut thicker glasses, the scribing tool can be set to various positions above the working surface 4 to form scribing marks with a range of depth values on the sheet of glass. The depth of the scribing mark is controlled by setting the scribing tool to a distance above the work surface, load force, scribing tool and glass conditions. In one example, the distance is half to two-thirds of the thickness of the sheet of glass. The depth of the scribing mark is measured from the top of the surface 3 to the bottom of the scribing mark within the body of the glass sheet. In another example manner of forming a scribe mark on a sheet of glass, the scribing tool 6 may be moved to an initial position at a distance from the working surface that is greater than the thickness of the sheet of glass to allow the sheet of glass to be put into position and held for scribing. Then, the cutting apparatus applies an operating pressure to the scribing tool 6 to lower it to the scribing position to form the scribe mark of a desired scribing depth. The scribing depth of the scribing tool 6 may be controlled on the cutting apparatus by the operator. In any event, the inventors have found that with thin glass sheets 2, because the scribing depth is very small the existing cutting apparatus (designed for thicker glass sheets) cannot always accurately adjust the position of the scribing tool 6 from its initial position to the lowest possible scribing position.

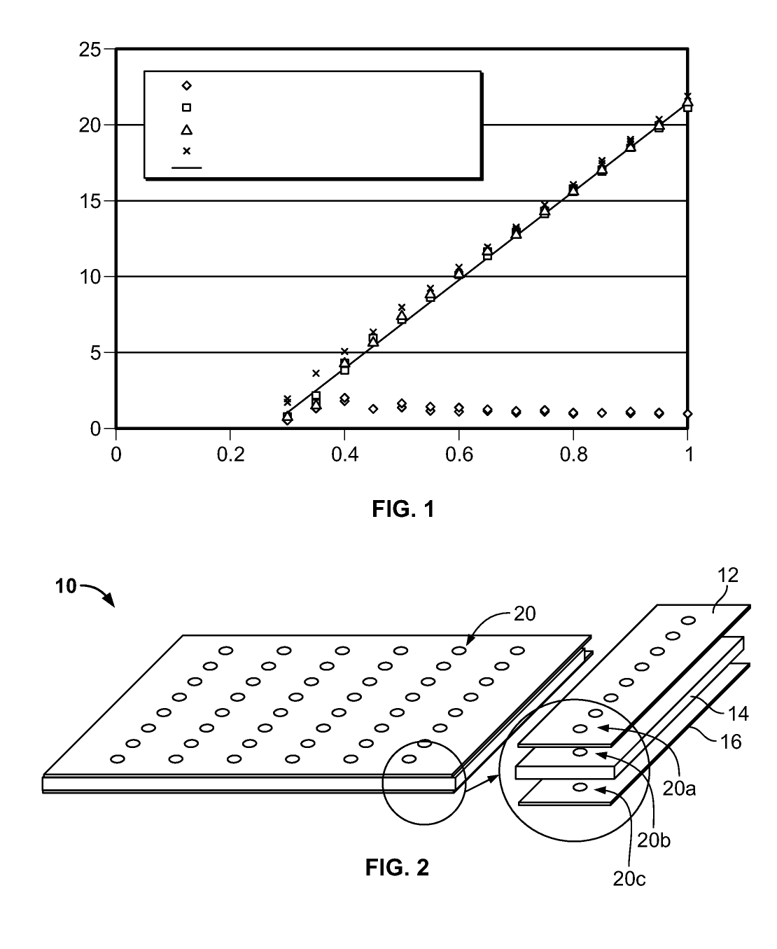

The graph of FIG. 1 illustrates the relationship between the load force acting on a sheet of glass 2 and the operating pressure applied by the cutting apparatus (designed for thicker glass sheets) on a scribing tool 6 for a number of different values of scribing depth. Specifically, the x-axis shows the operating pressure applied by the cutting apparatus on the scribing tool 6 (kgf/cm²) while the y-axis shows the load force developed on the sheet of glass 2 (N) by the scribing tool 6, as measured by a load cell placed on the sheet of glass 2. The diamond points indicate values for a scribing depth of 0.1 mm, the square points indicate values for a scribing depth of 0.2 mm, the triangle points indicate values for a scribing depth of 0.3 mm, the X points indicate values for a scribing depth of 0.4 mm, and the line is an interpolation of the values for the scribing depth of 0.2 mm.

FIG. 1 shows that, for lowest possible scribing depths of 0.2 mm or more, where the operating pressure applied by the cutting apparatus on the scribing tool 6 is about 0.3 kgf/cm² or higher, the load force acting on the sheet of glass 2 is linearly proportional to the operating pressure applied on the scribing tool 6. However, for a lowest possible scribing depth of 0.1 mm, increasing the operating pressure applied by the cutting apparatus on the scribing tool 6 does not increase the load force acting on the sheet of glass 2. Thus, it can be observed that if the scribing tool 6 is not sufficiently lowered, as when the value of scribing depth is too small, the increase in the operating pressure applied on the scribing tool 6 will not result in an increase of the load force acting on the sheet of glass 2. Moreover, the proportionality between the load force acting on the sheet of glass 2 and the operating pressure applied by the cutting apparatus on the scribing tool 6 will occur only if the operating pressure is at least a given value (e.g., 0.3 kgf/cm²). If the operating pressure is below the given value, there will be very little load force acting on the sheet of glass 2 (i.e., the cutting apparatus enters a “dead zone” of operating pressures, wherein the pressure applied by the cutting apparatus to the scribing tool 6 cannot develop a sufficient force on the sheet of glass to form an adequate scribe line).

Many cutting apparatus known in the art are designed for forming a scribing mark on sheets of glass with thicknesses ranging from 0.4 mm to 4 mm (thicker glasses). However, thin sheets of glass 2, for example with thickness of 0.2 mm or less (for example, 0.2, 0.19, 0.18, 0.17, 0.16, 0.15, 0.14, 0.13, 0.12, 0.11, 0.1, 0.09, 0.08, 0.07, 0.06, 0.05, 0.04, 0.03, 0.02, 0.01 mm), also need to be cut into smaller portions after forming scribing marks thereon. In the case of thin glass sheets 2, the scribe depth is much smaller than 0.2 mm. In order to prevent the scribing tool 6 from cutting completely through the thickness of these thin sheets of glass 2, the operating pressure applied by the cutting apparatus on the scribing tool 6 should be maintained at a lower range compared to the thicker sheets of glass. However, at the same time, the operating pressure cannot be so low (as when a scribe depth of 0.2 mm or less is used) as to fall within the dead zone of operating pressures. Moreover, it is also necessary for the scribing depth of the scribing tool 6 to be sufficiently large such that proportionality between the loading force and the operating pressure occurs, and so that an adequate scribe line is formed in the surface of the thin glass sheet 2.

In order to allow cutting apparatuses (designed for thicker glass sheets) economically and simply to be retro-fit to adequately cut thin glass sheets, the inventors have found that a pad 10 may be used to support the thin glass sheet 2 on the working surface 4 of a cutting apparatus having a scribing tool 6.

FIG. 2 illustrates an example embodiment of a compressible pad 10 configured to facilitate cutting thin sheets of glass 2 on cutting apparatuses designed to cut thicker glass. The pad 10 is configured to be placed on the working surface 4 and a sheet of thin glass 2 is placed on top of the pad 10 such that the pad 10 is placed between the working surface 4 and the sheet of thin glass 2 as shown in the cross-sectional views of FIGS. 3-4. The pad 10 is configured so that when it is subjected to a compressive force, it deforms substantially in the thickness direction. The thin sheets of glass 2 may have a thickness of 0.2 mm or less (for example, 0.2, 0.19, 0.18, 0.17, 0.16, 0.15, 0.14, 0.13, 0.12, 0.11, 0.1, 0.09, 0.08, 0.07, 0.06, 0.05, 0.04, 0.03, 0.02, 0.01 mm) while the thickness of the pad 10 may be in the range of 1.5-2.2 mm.

When scribing thin sheets of glass 2 with a given thickness using the pad 10 with a given pad thickness and the scribing position (of the scribing tool) is at a given distance from the working surface 4, the sum of the given pad thickness and the given thickness of the sheet of glass 2 should be more than the given distance so that scribing will occur. As with scribing without the pad, the scribing depth would still be measured from the top surface of the sheet of glass 2.

The pad 10 may include two or more layers 12, 14, 16 each of which may have different properties and functions.

The top-most, or upper surface, layer 12 should be one that is sufficiently stiff so that the pad 10 provides initial support to the glass whereby as stress is applied the pad provides sufficient reaction force to allow the cutting wheel to apply a scribe force on the glass. The top-most layer 12 provides support to the thin glass 2 to prevent localized bending that would cause uncontrolled glass fracturing. The Shore A hardness of the top layer 12 of the pad 10 may be in the range of 5-35. This material should be one that does not contaminate the glass, allow a good vacuum to be applied between the glass and the material, and be non-abrasive with the glass.

Inner layer 14 should be very compressible, and provides the “fail safe” against over pressure being applied by the scribing tool (which over pressure would break the thin glass), i.e., the inner layer should deform with increased scribing-tool-movement distance in the z-direction (up and down direction as directions are shown in FIG. 3), so that the glass sees a narrow change in load and one that stays within a desirable range for making a sufficient scribe line. The materials in this layer 14 are “fluffy” or “porous” or materials with Young's modulus values lower than the top-most layer 12 and deform relatively easily.

The lower-most, or bottom, layer 16 is one that acts as a protective skin. This material should be stiff enough to prevent damage to the inner layer 14 by forces acting through the bottom of the pad, as well as during shipping/handling, installation, adjustment, etc. This material should be one that can hold the shape of a hole so that the pad can be aligned with the holes in the working surface of the cutting apparatus of which scribing tool 6 is a part. This material should also promote a good vacuum seal between the working surface 4 and the pad 10, thereby allowing the vacuum to extend through the pad and ultimately to the glass so as to hold the glass to the working surface. The material in this layer can be the same as, or different from, the material in the top layer. Additionally, this lower-most layer 16 may be present initially but then removed if the pad 10 is permanently attached to the working surface 4. This material should prevent loose particles from the inner layer contaminating the working surface 4 which may in turn contaminate the sheets of glass 2.

The pad 10 may further include a plurality of passages 18 that extend in thickness directions and are configured to be aligned with the vacuum holes 8 provided on the working surface 4, of the cutting apparatus, so that the suction force generated through the vacuum holes 8 may extend through the pad 10 and the suction force may be applied on the sheet of glass 2 to secure the sheet of glass 2 relative to the working surface 4. Thus, all of the layers 12, 14, 16 of the pad will have holes 20 that are configured to be aligned with the vacuum holes 8 and define the passages 18. Alternatively to having discrete holes, the material (or at least a portion thereof) of any particular layer may be of a porous nature (i.e., one having tortuous paths therethrough) so as to allow the vacuum developed at the working surface 4 to act on the thin glass sheets 2. In one example embodiment, the pad includes a top layer 12, an intermediate layer 14 and a bottom layer 16 which may include a first set of holes 20a, a second set of holes 20b and a third set of holes 20c respectively.

The material of which the pad 10 is made may provide properties, for example, compressibility or pliability and may include polyvinyl chloride and polyester materials, for example.

While all of the layers 12, 14, 16 may be made of the same material, each layer 12, 14, 16 may be structurally distinct in order to perform their respective functions. In one example, the intermediate layer 14 may have a porous configuration so as to be more compressible than the top layer 12 and the bottom layer 16, whereas the top layer 12 and the bottom layer 16 may be relatively thinner but denser and stiffer than the intermediate layer 14. The top layer 12 may be configured to provide the majority of reaction force in response to the force applied by the scribing tool 6. The intermediate layer 14 may be configured to undergo compressive deformation thereby: i) allowing the scribing tool 6 to reach a scribing position, or travel distance, that is sufficiently great enough, while maintaining the small scribe depth associated with thin glass sheets; ii) raising the operating pressure applied by the cutting apparatus on the scribing tool 6 to be sufficiently great enough so as to avoid the “dead zone” of operating pressures; and iii) limiting, by absorbing some of, the pressure/load force acting on the sheet of glass 2 to a range of values sufficient to form a consistent scribe line yet not so high as to cause the scribing tool 6 to cut through, or otherwise damage, the sheet of thin glass 2. The top layer 12 and intermediate layer 14 of pad 10 can be configured such that the majority of the deformation is from the intermediate layer 14 and wherein the top layer 12 will not undergo much local deformation relative to its immediate neighboring area. Acting together, the top layer 12 and the intermediate layer 14 will resist a force up to 4-5 N, and then the intermediate layer 14 will further deform to absorb additional furces, thereby limiting the force applied to the thin glass sheets 2.

The bottom layer 16 may be configured to reduce leakage around the vacuum holes 8. In one example, the pressure applied on the thin sheets of glass 2 for scribing, as opposed to an operating pressure applied on the scribing tool 6, may be in the range of 29 to 43 kPa. Such a pressure is equivalent to a force of 4-5 N and may be applied using a cylinder.

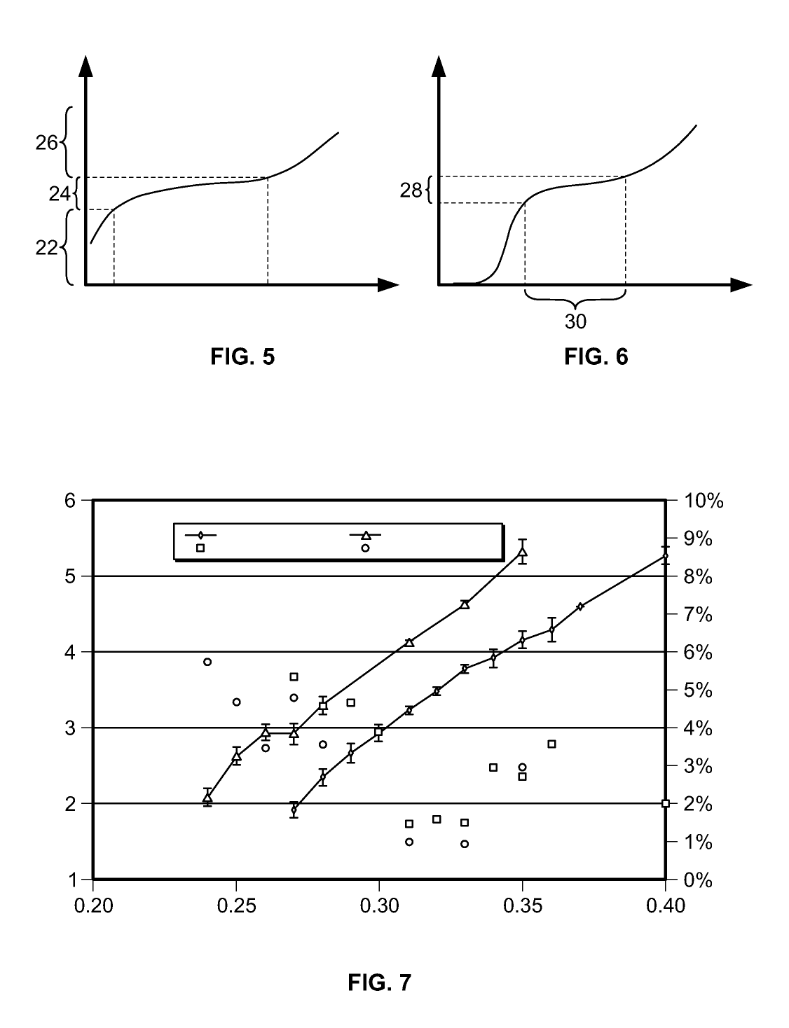

The combination of the layers 12, 14, 16 may cause the pad 10 to exhibit variable viscoelasticity as illustrated by the slope of the graph of compressive stress on the pad 10 versus the compressive strain of the pad 10, as shown in FIG. 5. In FIG. 5, the x-axis illustrates compressive strain in the pad 10 upon application of a compressive stress as illustrated on the y-axis. As the compressive stress is continuously increased in an order of a first range 22, a second range 24 and a third range 26 shown on the y-axis in FIG. 5, the viscoelastic property of the pad 10 varies in each range. The viscoelasticity exhibited by the pad 10 is lower and is substantially different when there is applied a compressive stress in the second range 24 than when there is applied a compressive stress in the first range 22 and also than when there is applied a compressive stress in the third range 26. As a result of the lower viscoelasticity in the second range 24, there is a large increase in strain for a relatively small increase in stress compared to the first range 22 and the third range 26 because at the start of the second range 24 the pad 10 reaches a threshold value for the compressive stress at which the intermediate layer 14 begins to undergo significant deformation. In a range of operating pressure applied on the scribing tool 6 corresponding to the third range 26 of compressive stress, an increase in the operating pressure leads to a larger increase in the load force acting on the sheet of glass 2 compared to the range of operating pressure corresponding to the second range 24.

The compressibility of the pad 10 allows for a more even surface on which to place a sheet of glass 2. When pressure is applied to the pad, the irregularities of the working surface 4 may be counterbalanced by the compressibility of the pad 10 such that a top surface of the pad 10 on which the sheet of glass 2 is placed has fewer irregularities. These irregularities of the working surface 4 may include surface variations, non-planarity, and non-parallelism with the motion of the scribing tool 6.

FIG. 6 illustrates another property of the pad 10 using the relationship of the load force (scribing force) acting on the sheet of glass 2, as shown along the y-axis of FIG. 6, in response to the operating pressure applied by the cutting apparatus on the scribing tool 6, as shown along the x-axis. In FIG. 6, the operating pressure applied on the scribing tool 6 may also be divided into a number of ranges that correspond to the first range 22, the second range 24 and the third range 26 of compressive stress in FIG. 5. When there is applied on the pad 10 a compressive stress in the first range 22 corresponding to a range of operating pressure applied on the scribing tool 6, the viscoelasticity of the pad 10 is exhibited by the top layer 12. The pad 10 may undergo some deformation in this range of operating pressure to build up a reactive force before it is sufficient to allow scribing to start on the sheet of glass 2. Scribing occurs at the end of the first range 22 and primarily in the second range 24. Specifically, the load force acting on the sheet of glass 2 tends to increase in a relatively steep manner in this range of operating pressure. When there is applied on the pad 10 a compressive stress in the second range 24 corresponding to a range of operating pressure applied on the scribing tool 6, the viscoelasticity of the pad 10 is exhibited by the intermediate layer 14. Because the porous or low modulus configuration of the intermediate layer 14 causes the pad 10 to undergo deformation in the second range 24 of compressive stress that is greater than deformation in the first range 22 of compressive stress, the reactive force of the pad 10 does not increase in the second range 24 of compressive stress as steeply as in the first range 22 of compressive stress while the operating pressure applied on the scribing tool 6 is increased. As a result, the viscoelasticity of the pad 10 in the second range 24 of compressive stress is such that, even if the operating pressure applied on the scribing tool 6 is increased, the load force acting on the sheet of glass 2 increases at a substantially lesser extent because the pad 10 absorbs a significant portion of the load force that would otherwise act on the sheet of glass 2. This allows the scribing tool 6 to apply a stable load force on the thin sheet of glass 2 by maintaining the load force within a narrow range 28, as shown in FIG. 6, despite greater variation in the operating pressure (shown by range 30) applied by the cutting apparatus on the scribing tool 6 and leads to higher quality scribing. The range of operating pressures applied on the scribing tool 6 in which all three of the aforementioned benefits are provide can be referred to as a process window 30 (FIG. 6) for operating pressures. An example process window of operating pressures is 0.31-0.35 kgf/cm². FIG. 7 is a graph showing the load force (N—on the y-axis, left side) acting on the sheet of glass 2 against the operating pressure applied by the cutting apparatus on the scribing tool 6 (kgf/cm²—on the x-axis) with a coefficient of variation (%—on the y-axis, right side).

Cutting thin sheets of glass 2 is facilitated by the pad 10 and by maintaining the operating pressures applied on the scribing tool 6 within the process window 30. Specifically, in the process window 30 of operating pressures, the deformation of the pad 10 allows the scribing tool 6 to be lowered so as to reach a value of the preset depth that is sufficient for roughly linear proportionality between the operating pressure applied by the cutting apparatus on the scribing tool 6 and the load force as seen by the sheet of glass 2 to exist as shown in FIG. 1. Moreover, in the process window 30 of operating pressures, the operating pressures applied on the scribing tool 6 are sufficiently high because the pad 10 deforms and absorbs some pressure applied to the sheet of glass 2 during scribing so that the operating pressure applied by the cutting apparatus on the scribing tool 6 is greater by at least a predetermined amount when the sheet of glass 2 is supported with the pad 10 than an operating pressure applied by the cutting apparatus on the scribing tool 6 when the sheet of glass 2 is not supported with the pad 10. This predetermined amount is illustrated in FIG. 7 and corresponds to the difference along the x-axis between the two curves. The curve on the left, which connects the triangle data points, shows the load force on the sheet of glass 2 without the pad 10, whereas the curve on the right, which connects the diamond data points, shows the load force on the sheet of glass 2 as supported by the pad 10, wherein for both curves, the x-axis shows the operating pressure applied by the cutting apparatus on the scribing tool 6. As can be seen from this figure, to achieve a given scribing force as seen by the glass, the pad increases the operating pressure applied by the cutting apparatus on the scribing tool. Because the operating pressure applied on the scribing tool 6 is raised by this predetermined amount, the dead zone of operating pressures can be avoided and the load force on the sheet of glass 2 can increase proportionally with the operating pressure applied on the scribing tool 6. The difference between the two curves along the y-axis (left side) in FIG. 7 corresponds to the force absorbed by the combination of the pad 10 and the sheet of glass 2.

For a given scribing pressure, consistent corresponding force is important for quality of scribing and separation in operation. This was exhibited in the low coefficient of variation of the scribe force corresponding to the window of operating pressures (in an example of 0.31-0.35 kgf/cm² cutting pressure as applied by the cutting apparatus on the scribing tool, which corresponds to a net scribing force of 3-4 N as seen by the glass). Higher coefficient of variation of the scribing force in the pre-scribe region 22 was confirmed in an example FIG. 7 that scribing pressure is unstable at low value range. After initial deformation at a higher load force rate in the region 22, the additional energy absorbed by the pad 10 reached a relatively stable rate and thus resulted in a more stable scribe force. For example, as shown in FIG. 7, over the range of scribing forces of 3-4 N, the scribing force with the pad (diamond data points) had a lower coefficient of variation of the scribing force (square data points) than did the scribing force without the pad (triangular data points, wherein coefficient of variation of the scribing force is shown by circular data points) over the same 3-4 N range of scribing forces seen by the glass.

### EXAMPLE 1

One example of the pad that was tested and found to work according to the principles described above was a pad having a total thickness of 1.8 mm. The pad included three layers, wherein: (i) an upper-most layer was made of a polyester material and had a thickness of 0.25 mm; (ii) an intermediate layer was made of porous polyvinyl chloride (PVC) and had a thickness of 1.4 mm; and (iii) a lower-most layer was made of a polyester material and had a thickness of 0.15 mm.

It will be apparent to those skilled in the art that various modifications and variations can be made without departing from the spirit and scope of the claimed invention.

For example, throughout the specification, the terms “scribe mark” and “scribe line” have been used interchangeably.

Further, although the pad is shown as including three layers, any desired number of layers may be used. For example, the inner layer 14 may include one or more different materials disposed in one or more sub-layers within the inner layer. Similarly, the upper-most 12 and lower-most layers 16 (shown) may include any number of sub-layers therein. In still other embodiments, the layer 16 may not be necessary, as when the layer 14 includes material that can form a sufficient vacuum seal with the working surface 4, or as when it is expected that the pad will be installed on the working surface 4 and not often moved.

What is claimed is:

1. A pad configured to be subjected to a compressive force applied substantially along a thickness direction, the pad having variable viscoelasticity such that, as an applied compressive stress is continuously increased in an order of a first range and a second range, the viscoelasticity is lower when there is applied a compressive stress in the second range than when there is applied a compressive stress in the first range.

2. The pad of claim 1, the pad including a top layer and an intermediate layer.

3. The pad of claim 2, when there is applied a compressive stress in the first range, the viscoelasticity of the pad is exhibited by the top layer, and when there is applied a compressive stress in the second range, the viscoelasticity of the pad is exhibited by the inter mediate layer.

4. The pad of claim 2, the intermediate layer having a porous configuration.

5. The pad of claim 2, the pad further including a bottom layer and having variable viscoelasticity such that, as a compressive stress is applied in a third range, the compressive stress in the third range being greater than that applied in the second range, the viscoelasticity exhibited by the pad is lower when there is applied a compressive stress in the second range than when there is applied a compressive stress in the third range.

6. The pad of claim 5, the pad having variable viscoelasticity such that, when there is applied a compressive stress in the third range, the viscoelasticity of the pad is exhibited primarily by the top and bottom layers.

7. The pad of claim 5, the pad including a plurality of passages extending in the thickness directions, the top layer, the intermediate layer and the bottom layer including a first set of holes, a second set of holes and a third set of holes respectively, the plurality of passages defined by alignment of the first set of holes, the second set of holes and the third set of holes so that they are in fluid communication with one another.

8. The pad of claim 1, wherein the pad is made of polyvinyl chloride or polyester material.

9. The pad of claim 1, wherein the pad has a thickness of about 1.5-2.2 mm.

10. The pad of claim 1, wherein the Shore A hardness is of 5-35 for the top layer of the pad.

11. The pad of claim 1, wherein the pad is configured to undergo greater deformation when there is applied a compressive stress in the second range than when there is applied a compressive stress in the first range such that a first range of reactive force exerted by the pad when there is applied a compressive stress in the first range is greater than a second range of reactive force exerted by the pad when there is applied a compressive stress in the second range.

12. A method of cutting a sheet of glass, the method including steps of:
placing a pad between a working surface and the sheet of glass;
securing the sheet of glass relative to the working surface;
scribing the sheet of glass secured relative to the working surface; and
separating a portion of the sheet of glass from the sheet of glass.

13. The method of claim 12, wherein the step of scribing includes applying an operating pressure on a scribing tool, the pad is configured to deform and absorb pressure applied to the glass sheet during the step of scribing such that an operating pressure applied on the scribing tool is greater by at least a predetermined amount when the sheet of glass is supported with the pad than an operating pressure applied on the scribing tool when the sheet of glass is not supported with the pad.

14. The method of claim 13, wherein the pressure applied on the sheet of glass with the pad is in a range of 29 to 43 kPa.

15. The method of claim 13, wherein the step of scribing the sheet of glass is conducted with a cutting wheel.

16. The method of claim 15, wherein the cutting wheel is configured so that at its closest possible position relative to the working surface, the cutting wheel is located at a given distance from the working surface, wherein the sheet of glass has a thickness less than or equal to the amount of the given distance, and wherein the thickness of the pad together with the thickness of the sheet of glass is an amount greater than the given distance.

17. The method of claim 12, wherein the step of securing the sheet of glass involves applying suction force on the sheet of glass, the suction force extending through the pad.

18. The method of claim 17, wherein the suction force is applied from the working surface.

19. A method of forming a scribing mark on a sheet of glass, the method including steps of:
placing a compressible pad between a sheet of glass and a working surface;
moving a scribing tool from a starting position toward the working surface so as to contact the sheet of glass;
applying a scribing force of a predetermined value on the sheet of glass using the scribing tool; and
moving the scribing tool further toward the working surface and into a scribing position so as to deform the compressible pad and move the sheet of glass toward the working surface without increasing the scribing force, applied on the sheet of glass by the scribing tool, significantly beyond the predetermined value,
wherein the scribing position reached by the scribing tool is at least a predetermined distance offset from the starting position, the predetermined distance measured in a direction substantially perpendicular to the working surface.

20. A method of forming a scribing mark on a sheet of glass, the method including steps of:
placing a compressible pad between a sheet of glass and a working surface;
moving a scribing tool toward the working surface so as to contact an elevation at which a top surface the sheet of glass is located;
applying an operating pressure on the scribing tool;
maintaining the operating pressure within a predetermined range at which a viscoelasticity of the compressible pad is substantially different compared to operating pressures outside the predetermined range; and
moving the scribing tool further toward the working surface and into a scribing position so as to deform the compressible pad and move the sheet of glass toward the working surface, the scribing position reached by the scribing tool being at least a predetermined distance offset from the elevation, the predetermined distance measured in a direction substantially perpendicular to the working surface.

21. (canceled)
